(19) United States
(12) Patent Application Publication
(10) Pub. No.: US 2010/0158794 A1
(43) Pub. Date: Jun. 24, 2010

(54) HEAT PIPE, HEAT PIPE REFORMER COMPRISING SUCH A HEAT PIPE, AND METHOD FOR THE OPERATION OF SUCH A HEAT PIPE REFORMER

(76) Inventor: Thomas Steer, Freising (DE)

Correspondence Address: HEAD, JOHNSON & KACHIGIAN, 228 W 17TH PLACE, TULSA, OK, 74119, US

(21) Appl. No.: 12/294,904

(22) PCT Filed: Apr. 4, 2007
(86) PCT No.: PCT/EP07/53288

§ 371 Date: Apr. 21, 2009

(30) Foreign Application Priority Data
Apr. 5, 2006 (DE) 10 2006 016 005.3

(51) Int. Cl. F28D 15/02; B01J 8/18; C01B 3/26

(52) U.S. Cl. 423/651; 165/104.21; 422/146

(57) ABSTRACT

A heat pipe and a method for operating a heat pipe of said type are provided, which heat pipe remains active over a relatively long period of time in particular when used in pressurized gasification atmosphere, that is to say in a hydrogen-rich environment. Also specified is a heat pipe reformer having a heat pipe of said type. By providing a hydrogen extractor in the region of the heat-dissipating end of the heat pipe, the hydrogen which has penetrated into the heat pipe and accumulated there is conducted out of the heat pipe again, such that the heat-exchanging capacity of the heat pipe is maintained. The hydrogen extractor generates a hydrogen concentration gradient or a hydrogen partial pressure gradient between the interior and the exterior of the pipe casing, such that hydrogen which has penetrated into the interior of the heat pipe is diffused into the hydrogen extractor and can be extracted from there. A hydrogen concentration gradient or hydrogen partial pressure gradient is also formed between the atmosphere surrounding the heat pipe, for example the atmosphere in a reforming fluidized-bed gasification chamber, and the hydrogen extractor, such that hydrogen from the surrounding atmosphere is also diffused into the hydrogen extractor and extracted from there.

The invention relates to a heat pipe according to the preamble of Claim 1, a heat pipe reformer according to Claim 11 having a heat pipe of said type, and a method according to Claim 12 for operating a heat pipe reformer of said type.

### PRIOR ART

Heat pipes have long been known as extremely effective heat transport systems. They are based on the principle of heat transfer by evaporation and condensation in a closed system. In contrast to large circuit systems with natural circulation, said evaporation and condensation takes place in a single pipe which is closed off in a gas-tight fashion. The pipe is evacuated and contains only a liquid which evaporates in the desired temperature range. During the evaporation, the liquid absorbs heat from a hot reservoir, and then dissipates said heat to a cold reservoir during the course of the condensation. It is significant that the evaporation and condensation in the heat pipe take place at the same pressure and therefore at the same temperature. The heat transfer rates are very high, such that heat transfer by means of a heat pipe takes place virtually without losses, that is to say without an additional driving temperature gradient.

In connection with heat pipes, a multiplicity of liquids have been tested as a heat carrier medium, which liquids are suitable for different temperature ranges. In the range of ambient temperatures, such as for example for cooling high-performance processors in the field of microelectronics, use is made inter alia of organic heat carriers (pentane, methanol, acetone etc.); in the high-temperature range, alkali metals are most suitable.

WO 00/77128 A1 discloses a pressurized reformer for generating combustion gas from carbon-containing feed materials by allothermic water vapour gasification in a fluidized bed. Heat pipes are used to introduce heat into the reforming fluidized bed.

In allothermic gasification reactors, sodium and potassium are most suitable as heat carrier media in heat pipes. Here, sodium is particularly expedient, since, of all the possible liquids, it has the highest heat of condensation (3913 kJ/kg at 900° C.), and a correspondingly low circulating mass flow is therefore generated. In the case of potassium, on account of the higher evaporation pressure, a slightly higher energy density is generated in the vapour (potassium approx. 2500 kJ/m³, sodium approx 1200 kJ/m³ at 900° C.). The overall suitability of a liquid as a heat carrier medium is indicated by the figure of merit. This is more than twice as high for sodium as it is for potassium, and therefore sodium is more expedient overall than potassium.

During operation of the reformer known from WO 00/77128 A1, it was observed that, in pressurized operation of the gasifier—in contrast to unpressurized operation—the heat pipes experience a considerable loss in heat-exchanging capacity within a few hours.

It is therefore an object of the present invention to specify a heat pipe whose heat-exchanging power decreases only to an insignificant extent over a relatively long time period in particular when used in a pressurized gasification atmosphere. It is also an object of the present invention to specify a heat pipe reformer having a heat pipe of said type and a method for operating a heat pipe reformer of said type.

Said objects are achieved by means of the features of Claims 1, 11 and 12.

### DESCRIPTION OF THE INVENTION

It was determined that a cause for the deactivation of the heat pipes was the fact that the wall material of the heat pipe is permeable to molecular hydrogen in the working range of 800-900° C., and the hydrogen diffuses into the interior of the heat pipe. The hydrogen is transported by the vapour flow of the heat carrier medium in the heat pipe primarily into the condensation region of the heat pipe, at the dead end of which said hydrogen becomes enriched as an inert gas. As a consequence, the partial pressure of the heat carrier medium is reduced there, as a result of which the condensation temperature is reduced. The condensation temperature falls below the operating temperature of the reactor, and the condensation is generated in the corresponding region. The hydrogen pressure in the heat pipe at the dead end of the condensation part corresponds approximately to the total pressure of the evaporation and condensation process of the heat pipe, which in turn corresponds to the vapour pressure of the heat carrier medium at the corresponding temperature.

In atmospheric operation, said enrichment firstly has no significant influence, since the evaporation pressure of sodium or potassium is high enough that the hydrogen leaves the heat pipe again by diffusion.

The vapour pressure of sodium is approx. 0.8 bar at 850° C., while that of potassium is approximately 2.3 bar. If one assumes a 30% hydrogen proportion on the product gas side, this corresponds to a partial pressure of 0.3 bar in the product gas. In an atmospheric reformer, therefore, the driving pressure difference is always high enough to expel the hydrogen from the heat pipe.

In pressurized operation, there is the problem that the total pressure within the heat pipe is close to or below the partial pressure of the hydrogen in the gasifier (reformer), such that there is no driving pressure gradient which could cause the hydrogen to leave the heat pipe again. 30% hydrogen in a pressurized gasifier with a pressure of 5 bar is equivalent to a partial pressure of the hydrogen of 1.5 bar. When using potassium (evaporation pressure 2.3 bar), therefore, there would still be a driving pressure gradient of approx. 0.8 bar to expel hydrogen out of the heat pipe toward the product gas, whereas this would not be the case when using sodium (evaporation pressure 0.8 bar).

By providing a hydrogen extractor in the region of the heat-dissipating end of the heat pipe, the hydrogen which has penetrated into the heat pipe and accumulated there is conducted out of the heat pipe again, such that the heat-exchanging capacity of the heat pipe is maintained. The hydrogen extractor generates a hydrogen concentration gradient or a hydrogen partial pressure gradient between the interior and the exterior of the pipe casing, such that hydrogen which has penetrated into the interior of the heat pipe is diffused into the hydrogen extractor and can be extracted from there. A hydrogen concentration gradient or hydrogen partial pressure gradient is also formed between the atmosphere surrounding the heat pipe, for example the atmosphere in a reforming fluidized-bed gasification chamber, and the hydrogen extractor, such that hydrogen from the surrounding atmosphere is also diffused into the hydrogen extractor and extracted from there.

Said hydrogen concentration gradient may be provided in a simple manner by means of a flushing duct which runs in and/or on the pipe casing and in which a hydrogen-depleted atmosphere prevails. Said hydrogen-depleted atmosphere may for example be produced by evacuating the flushing duct, which is closed off at one side, by means of a vacuum pump (Claim 2).

In the advantageous refinement of the invention according to Claim 4, a hydrogen-depleted atmosphere is created in a simple manner in the flushing duct.

The advantageous refinement of the invention according to Claim 5 yields a simple option for providing flushing ducts. It is important here that the pipe casing and the cladding pipe are in close contact and there is a sufficient contact area between the two pipes to provide a good heat transfer from the interior to the environment of the heat pipe.

Said hydrogen partial pressure gradient or hydrogen concentration gradient may be ensured in a simple manner by heating the hydrogen extractor (Claim 10).

As already mentioned, the heat pipes according to the present invention are preferably used for coupling heat into the reforming fluidized bed of a heat pipe reformer, in particular in reformers as are known from WO 00/77128 A1 (Claim 11).

It is self-evident that all of these features also improve the effectiveness of heat pipes in unpressurized operation in a hydrogen-rich atmosphere. The invention is therefore not restricted to the operation of heat pipes in a pressurized operational environment.

The other subclaims relate to further advantageous refinements of the invention.

Further details, features and advantages of the invention can be gathered from the following description of exemplary embodiments of the invention on the basis of the drawing, in which:

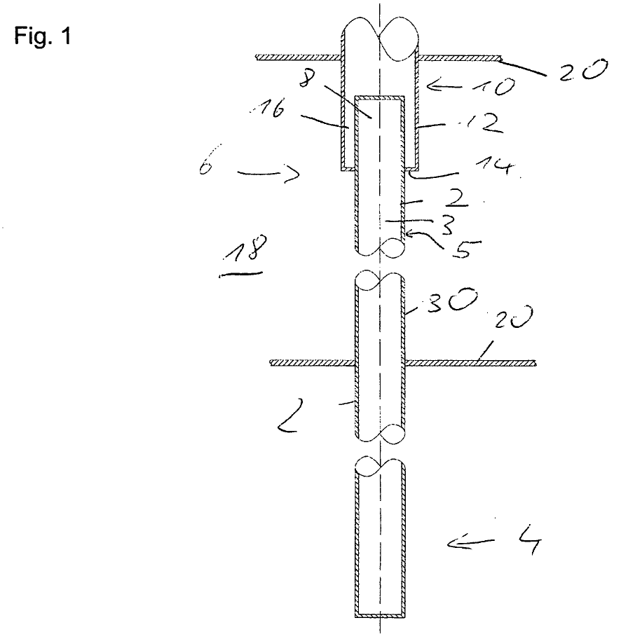

FIG. 1 is a schematic illustration of a first embodiment of a heat pipe according to the present invention,

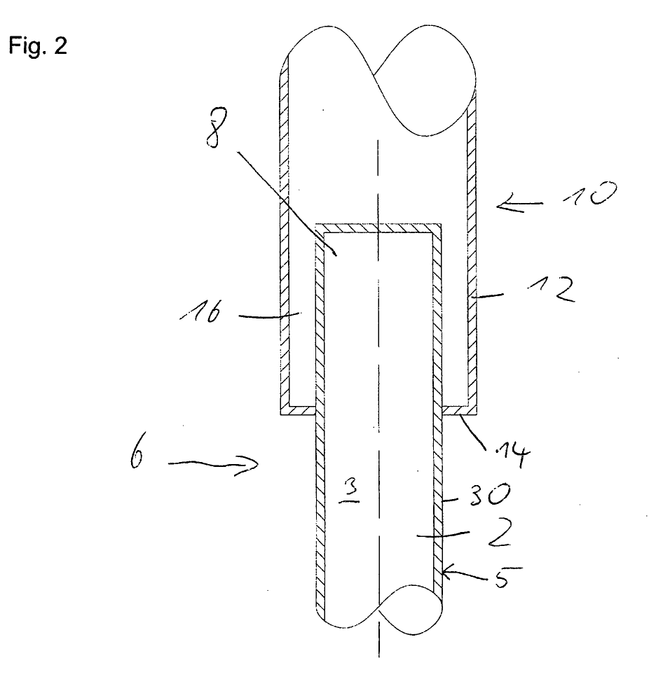

FIG. 2 shows a detail of the embodiment according to FIG. 1,

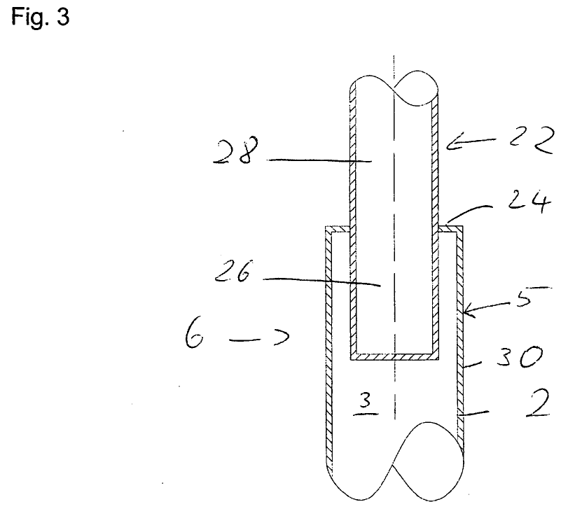

FIG. 3 is a detail illustration, corresponding to

FIG. 2, of a second embodiment of the invention,

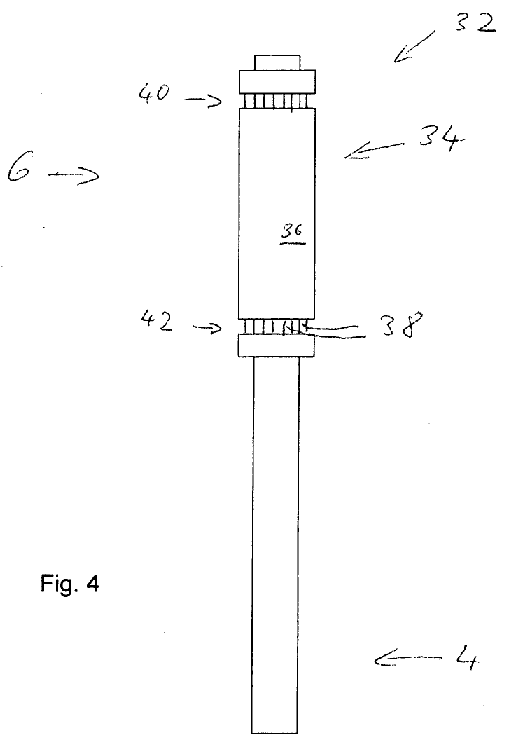

FIG. 4 is a schematic illustration of a second embodiment of the invention,

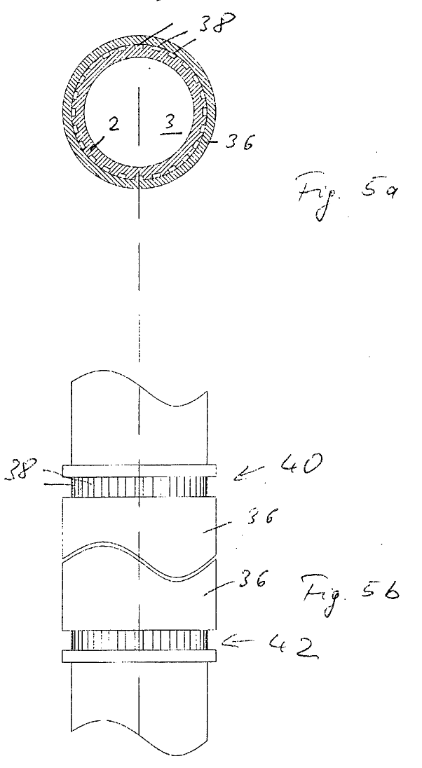

FIGS. 5a and 5b show details of the second embodiment according to FIG. 4, and

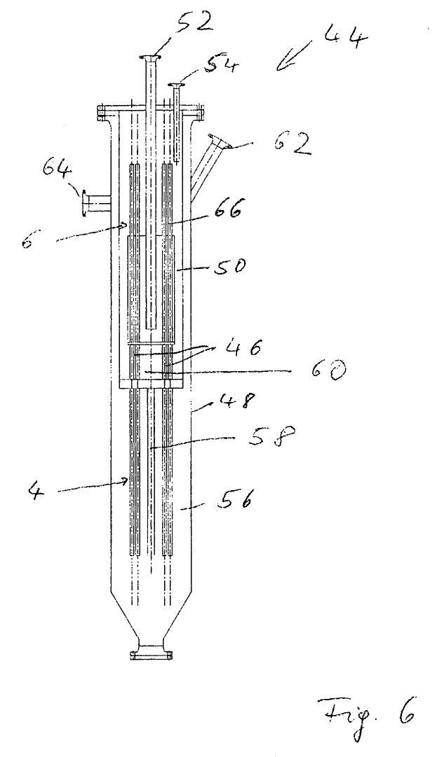

FIG. 6 shows a heat pipe reformer having heat pipes according to the present invention.

FIGS. 1 and 2 show a first embodiment of the invention. A heat pipe 1 according to the first embodiment of the invention comprises a pipe casing 2 which is composed of metal and in the interior 3 of which a heat carrier medium circulates in a known manner. The heat pipe 1 comprises a heat-absorbing end 4 and a heat-dissipating end 6. The outer side 5 of the pipe casing is consequently formed as heat-exchanger surface or has the function of a heat-exchanger surface. A part 8 of the heat-dissipating end 6 is surrounded by a hydrogen extractor 10 with a casing 12. The hydrogen extractor 10 is likewise tubular and has a larger diameter than the pipe casing 2. The tubular hydrogen extractor 10 is pushed over the heat-dissipating end 6 of the pipe casing 2 and is welded in a gas-tight fashion by means of a base 14. In this way, an annular space 16 is formed which is delimited at one side by the casing 12 of the hydrogen extractor 10 and at the other side by the part 8 of the pipe casing 2.

The hydrogen which has accumulated in the part 8 of the heat pipe diffuses into said annular space 16 and is collected or evacuated. The heat-dissipating end 6 of the heat pipe is situated in a hydrogen-rich operational environment, for example in the reforming fluidized bed 18 which is enclosed in a pressure container 20. Here, the hydrogen extractor 10 extends through the pressure container 20, such that the hydrogen can be discharged to the environment.

The second embodiment of the invention which is schematically illustrated in FIG. 3 differs from the first with regard to the design of the hydrogen extractor. A heat pipe 21 has a hydrogen extractor 22 which is likewise tubular but has a smaller diameter than the pipe casing 2. The hydrogen extractor 22 extends through the end side 24 of the heat-dissipating end 6 of the heat pipe and protrudes in the manner of a finger into the pipe casing 2. A part 26 of the hydrogen extractor 22 is therefore situated in the interior of the pipe casing 2, and a part 28 of the hydrogen extractor 22 projects out of the pipe casing 2.

In the second embodiment according to FIG. 2, it should be noted that the wall of the hydrogen extractor 22 may, to improve the flow of the heat carrier medium, be provided with a wick structure.

In both embodiments, that part of the cladding pipe 2 which is situated in the hydrogen-rich operational environment is provided with a coating 30 which forms a hydrogen diffusion barrier.

FIGS. 4 and 5 show a third embodiment of the invention. A heat pipe 32 is provided with a hydrogen extractor 34. The hydrogen extractor 34 extends over the greater part of the heat-dissipating end 6 of the heat pipe 32. The hydrogen extractor 34 comprises a cladding pipe 36 whose inner diameter is approximately equal to the outer diameter of the pipe casing 2. The cladding pipe 36 is pushed over the heat-dissipating end 6 of the heat pipe 32 and is shrunk onto the pipe casing 2. Flushing ducts 38 extend between the cladding pipe 36 and the outer side 5 of the pipe casing 2 over the length of the cladding pipe 36. As can be seen from FIG. 5, the flushing ducts 38 are formed by depressions or grooves which are formed into the outer side 5 of the pipe casing 2 and which can be covered towards the outside by the cladding pipe 36. A flushing gas inlet 40 is provided at one end of the cladding pipe 36, and a flushing gas outlet 42 is provided at the other end of the cladding pipe 36, into which flushing gas inlet 40 and flushing gas outlet 42 the flushing ducts 38 open out. The flushing ducts 38 extend parallel to the longitudinal axis of the heat pipe 32 and are distributed in an equidistant fashion over the circumference of the pipe casing 2, as can be seen from FIGS. 5a and 5b. The invention is however not restricted to this arrangement of the flushing ducts; any other form of geometric arrangement of the flushing ducts is also conceivable.

When using the heat pipe 32 in a hydrogen-rich atmosphere, the flushing ducts 36 are traversed continuously, or at defined time intervals, by a hydrogen-depleted flushing gas. This generates a hydrogen concentration gradient between the interior 3 of the heat pipe 32 and the flushing ducts 38, which hydrogen concentration gradient leads to the hydrogen which has penetrated into the interior 5 of the heat pipe 32 diffusing through the outer casing 2 and into the flushing ducts, and being removed with the flushing gas from the region of the heat-dissipating end 6 of the heat pipe 32.

The above-described hydrogen extractor 10, 22 and 34 may also be combined with one another, for example by virtue of the hydrogen extractor 34 additionally being heated.

The heat pipes according to the present invention are particularly suitable for use in a heat pipe reformer as is known from WO 00/77128 A1. In this respect, reference is made to the entire content of the description of said document.

FIG. 6 shows a heat pipe reformer 44 of said type, in which are installed a multiplicity of heat pipes 46. The heat pipes 46 may be heat pipes according to the above-described embodiments. The heat pipe reformer 44 comprises the pressure container 48 which is of tubular design. A reforming fluidized-bed gasification chamber 50 is arranged in the upper region of the heat pipe reformer 44 or of the pressure container 48, in which fluidized-bed gasification chamber 50 hydrogen-containing combustion gas is generated from carbon-containing feed materials by allothermic water vapour gasification. The carbon-containing feed materials are introduced into the fluidized-bed gasification chamber 50 by means of a supply device 52. The product gas which is generated in the reforming fluidized-bed gasification chamber 50 is extracted via a product gas outlet 54. A fluidized-bed furnace 56 as an external heat source is arranged in the lower region of the heat pipe reformer 44 or of the pressure container 48. The fluidized-bed furnace 56 is fired with coke which is extracted out of the fluidized-bed gasifier 50 via a coke extractor 58 and a pressure lock 60. Alternatively, the fluidized-bed furnace 56 may also be heated with the feed material in the fluidized-bed gasifier 50 or any other feed materials. Said fuels may be supplied to the fluidized-bed furnace 56 via a fuel inlet 62. The flue gas which is generated in the fluidized-bed furnace 56 is extracted via a flue-gas extractor 64. The heat pipes 46 are provided, in the region of the heat-dissipating end 6, with a hydrogen extractor 66 which is a hydrogen extractor according to the above-described embodiments of the heat pipes 1, 21, 32, or is a hybrid form of these.

The elongate, tubular heat pipes 46 protrude with the heat-absorbing end 4 into the fluidized-bed furnace 56 and with the heat-dissipating end 6 into the fluidized-bed gasification chamber 50. The heat pipes 46 thereby transfer the heat which is generated in the fluidized-bed furnace 56 into the heat-consuming fluidized-bed gasification chamber 50. At the operating temperatures, in the range of 800-900° C., which prevail in the fluidized-bed gasification chamber 50, the metallic pipe casing 2 and also the cladding pipe 36—both pipes are preferably composed of high-temperature-resistant high-grade steel—are permeable to molecular hydrogen, such that hydrogen can pass out of the combustion gas into the interior 3 of the heat pipe 46. Said hydrogen can be extracted from the interior 3 of the heat pipe 46 again via the hydrogen extractor 10, 22, 34.

In the event that the heat pipes 32 are used as heat pipes 46, the flushing gas for flushing out the hydrogen may at the same time be used to fluidize the fluidized bed in the fluidized-bed gasification chamber 50.

### LIST OF REFERENCE SYMBOLS

1 Heat pipe

2 Pipe casing

3 Interior of 2

4 Heat-absorbing end

5 Outer side of 2

6 Heat-dissipating end

8 Part of 6

10 Hydrogen extractor

12 Casing of 10

14 Base of 10

16 Annular space

18 Reforming fluidized bed

20 Pressure container

21 Heat pipe

22 Hydrogen extractor

24 End side of 2

26 Part of 22 in the interior of 2

28 Part of 22 outside 2

30 Coating

32 Heat pipe

34 Hydrogen extractor

36 Cladding pipe

38 Flushing ducts

40 Flushing gas inlet

42 Flushing gas outlet

44 Heat pipe reformer

46 Heat pipe

48 Pressure container

50 Reforming fluidized-bed gasification chamber

52 Supply device for introducing the carbon-containing feed materials which are to be gasified

54 Product gas extractor

56 Fluidized-bed furnace

58 Coke extractor

60 Pressure lock

62 Fuel inlet

64 Flue-gas extractor

66 Hydrogen extractor

1. Heat pipe having
a pipe casing (2) which is composed of metal and in the interior (3) of which circulates a heat carrier medium, with the pipe casing (2) having an outer side (5) which is formed at least partially as a heat-exchanger surface,
a heat-absorbing end (4) and
a heat-dissipating end (6),
characterized
in that a hydrogen extractor (10, 22, 34) is provided at least in one partial region of the heat-dissipating end (6) of the heat pipe, which hydrogen extractor (10, 22, 34) provides a hydrogen concentration gradient/hydrogen partial pressure gradient between the interior (3) of the pipe casing (2) and the outer side (5) of the pipe casing (2).

2. Heat pipe according to claim 1, characterized in that the hydrogen extractor (32) comprises at least one flushing duct (38) which runs in and/or on the pipe casing (2) and in which a hydrogen-depleted atmosphere prevails.

3. Heat pipe according to claim 2, characterized in that the at least one flushing duct is formed by a bore which is formed into the pipe casing (2) of the heat pipe.

4. Heat pipe according to claim 2 or 3, characterized in that a hydrogen-depleted flushing gas flows in the at least one flushing duct (38).

5. Heat pipe according to one of the preceding claims 2 to 4, characterized in that the hydrogen extractor (32) comprises a cladding pipe (36) which encloses the pipe casing (2) of the heat pipe, and in that the at least one flushing duct (38) is arranged between the cladding pipe (36) and the pipe casing (2).

6. Heat pipe according to claim 5, characterized in that the at least one flushing duct (38) is formed by a groove which is formed into the pipe casing (2) of the heat pipe and/or into the cladding pipe (36).

7. Heat pipe according to one of the preceding claims 2 to 6, characterized in that the at least one flushing duct (38) is provided with a flushing gas inlet (40) and with a flushing gas outlet (42).

8. Heat pipe according to one of the preceding claims 2 to 7, characterized in that a plurality of flushing ducts (38) run in the longitudinal direction of the heat pipe.

9. Heat pipe according to one of the preceding claims 2 to 6, characterized in that the at least one flushing duct runs in a spiral shape along the heat pipe.

10. Heat pipe according to one of the preceding claims, characterized in that the hydrogen extractor (10; 22) is heated.

11. Heat pipe reformer for generating combustion gas from carbon-containing feed materials by allothermic steam gasification, having
a reforming fluidized-bed gasification chamber (50) with a fluidized bed,
a supply device (52) for supplying the feed materials into the fluidized-bed gasification chamber (50),
an inlet line (54) into the fluidized-bed gasification chamber (50) for water and/or water vapour,
an external heat source (56) and
a heat pipe arrangement having at least one heat pipe (46) for transferring heat from the external heat source (56) into the reforming fluidized-bed gasification chamber (50),
characterized
in that the at least one heat pipe (46) is a heat pipe (1; 21; 32) according to one of the preceding claims 1 to 10.

12. Method for operating a heat pipe reformer according to claim 11, characterized in that the flushing gas for removing the hydrogen from the at least one flushing duct (38) is used to fluidize the fluidized bed.
